(19) United States
(12) Patent Application Publication
(10) Pub. No.: US 2014/0359655 A1
(43) Pub. Date: Dec. 4, 2014

(54) IN-FLIGHT ENTERTAINMENT SYSTEM

(71) Applicant: THOMSON LICENSING, Issy de Moulineaux (FR)

(72) Inventor: Eric Diehl, Issy (FR)

(73) Assignee: THOMSON LICENSING, Issy de Moulineaux (FR)

(21) Appl. No.: 14/372,902

(22) PCT Filed: Jan. 14, 2013
(86) PCT No.: PCT/EP2013/050569

§ 371 Date: Jul. 17, 2014

(30) Foreign Application Priority Data
Jan. 20, 2012 (EP) 12305073.4
Apr. 26, 2012 (EP) 12165599.7

(51) Int. Cl. H04N 21/214; H04N 21/8358; H04N 21/4405; H04N 21/472; H04N 21/258; H04N 21/414

(52) U.S. Cl. CPC H04N 21/2146; H04N 21/25816; H04N 21/25841; H04N 21/25875; H04N 21/41407; H04N 21/41422; H04N 21/4405; H04N 21/47202; H04N 21/47217; H04N 21/8358
USPC 725/31; 725/25

(57) ABSTRACT

A content delivery system comprising a content database storing a content item and a content license; a video server configured to retrieve the content item and the content license from the content database and to send them to a player device; a registration server configured to receive credentials from a user player device, to generate user information from the credentials, to forward the user information to an application server; an application server configured to generate a personalised player application for the user player device; and a license server configured to receive a content license and a user identity from the user player device, to check with the registration server that a user corresponding to the user identity is authorized to access the content item, to decrypt the content license using a system license key and re-encrypt the decrypted content license using a user license key to obtain a user license, and to send the user license to the user player device. Also provided is a content rendering method.

### TECHNICAL FIELD

The present invention relates to protection of digital content and finds particular use in In-Flight Entertainment (IFE) systems.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In current IFE systems, a server on the airplane provides a plurality of different films to a plurality of users. Usually, each user is able to watch a film independently of all the other users. To achieve this, the user requests a desired content that then is streamed by the server.

Current IFE systems have two main characteristics:
Content in the system is unprotected except for the intermittent addition of a visible, often semi-transparent, watermark that identifies the airline company. This can prove insufficient to deter theft, in particular in view of the hospitality release window, i.e., airlines receive films close to their theatrical release dates.
The system only renders content on screens associated with the seats in the airplane, e.g., inserted in the back of the seat just in front or in the armrest of the seat.

It is assumed that the development goes towards providing High Definition (HD) content, which makes the IFE systems good targets for piracy attempts, and towards the ability for passengers to stream the content to their own devices, such as for example tablets and computers.

Current IFE systems are not suited for these developments and it will thus be appreciated that there is a need for a solution that provides an improved IFE system. The present application provides such a solution.

### SUMMARY OF INVENTION

In a first aspect, the invention is directed to a method of rendering a content item. A device having a processor executes a player and renders the content item. At at least one point of time during execution of the method, the device verifies the presence of a proximity server; and stops the rendering of the content item in case the proximity server is not present.

In a first preferred embodiment, the device has a user identity and the player has been personalised to comprise the user identity and a user license key for the device. The device sends a content license for the content item and the user identity to a license server; obtains a user license for the content item from the license server; decrypts the user license using the user license key to obtain a scrambling key and descrambles the content item using the scrambling key.

It is advantageous that the device further watermarks the content between descrambling and rendering, the watermark in particular being a user watermark identity.

It is also advantageous that the device sends user credentials to a registration server and receives the player.

It is also advantageous that the device obtains the content item and the content license.

It is also advantageous that the user license has been generated from the content license.

In a second aspect, the invention is directed to a content delivery system comprising a content database configured to store at least one content item and a corresponding content license; a video server configured to retrieve a content item and a corresponding content license from the content database and to send the retrieved content item and corresponding content license to a player device; an application server configured to receive user information from the registration server, to generate a personalised player application for the user player device and to deliver the personalised player application to the user player device; a license server configured to receive a content license and a user identity from the user player device, to check with the registration server that a user corresponding to the user identity is authorized to access the content item, to decrypt the content license using a system license key and re-encrypt the decrypted content license using a user license key to obtain a user license, and to send the user license to the user player device; and a proximity server configured to participate in a challenge-response protocol with the user player device.

In a first preferred embodiment, the content delivery system further comprises a registration server configured to receive credentials from a user player device, to generate the user information from the credentials, to forward the user information to an application server.

In a second preferred embodiment the content delivery system further comprises a system player device comprising the system license key, the system player device being configured to receive the content item and the corresponding content license, to decrypt the content license using the system license key to obtain a scrambling key, to descramble the content item using the scrambling key, and to render the descrambled content item.

In a third preferred embodiment, the system player device is further configured to embed a watermark in the descrambled content item before rendering.

### BRIEF DESCRIPTION OF DRAWINGS

Preferred features of the present invention will now be described, by way of non-limiting example, with reference to the accompanying drawings, in which

FIG. 1 illustrates an In-Flight Entertainment system according to a preferred embodiment of the present invention;

FIG. 2 illustrates a method for accessing content by a fixed player according to a preferred embodiment of the present invention; and

FIG. 3 illustrates a method for accessing content by a mobile player according to a preferred embodiment of the present invention.

### DESCRIPTION OF EMBODIMENTS

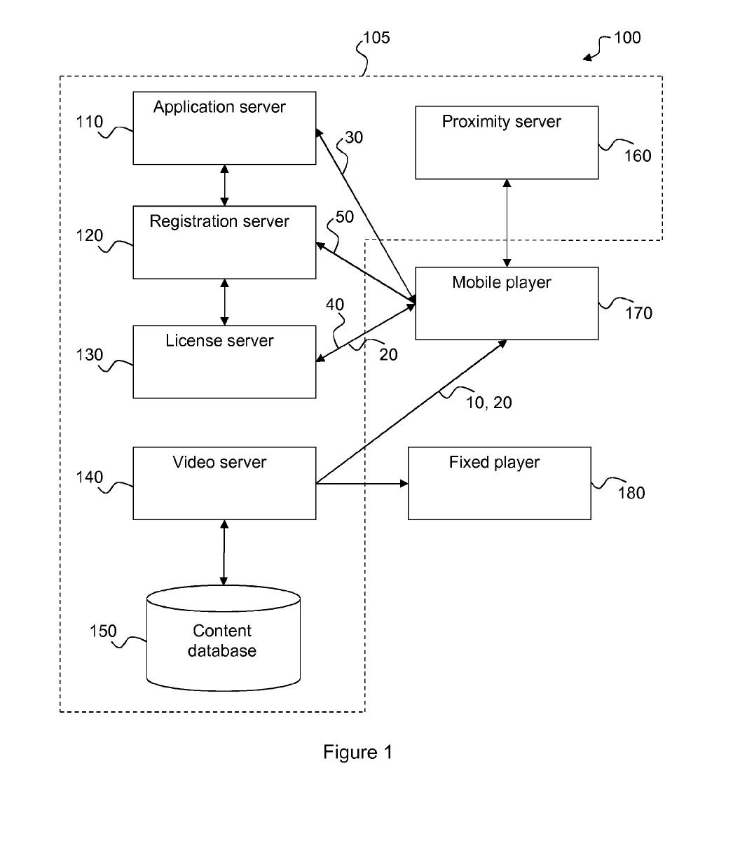

FIG. 1 illustrates an In-Flight Entertainment system (IFE) according to a preferred embodiment of the present invention. The IFE is advantageously implemented onboard a vehicle, in particular an airplane that will be used as a non-limitative example hereinafter.

The IFE 100 comprises a head-end 105 and at least one player. The player may be a fixed player 180 that is managed by the system and, usually, fixed to the airplane; an example is a screen attached to the back of the seat of the row in front. The player may also be a mobile player 170, e.g. a tablet or a computer, that is not managed by the IFE, but by a user. This is to say that the IFE head-end 105 controls the software and so on of the fixed player 180, but not of the mobile player 170. It is assumed that the mobile player 170 is capable of downloading and executing software applications.

The IFE head-end 105 preferably comprises:
A video content database 150 configured to store content and licenses for the content.
A video server 140 configured to retrieve a content item 10 and the associated content license 20 from the video database 150 and to send the content license 20 to a player 170, 180 and also to stream the content 10 to the player.
A license server 130.
A registration server 120.
An application server 110.
A proximity server 160.

The skilled person will appreciate that the features are logical features that may be implemented as separate devices or grouped together in any possible manner.

Each device in the system comprises the necessary hardware and software needed for performing its functions, such as memory, at least one processor, at least one interface for interaction with other devices and a user interface.

The content 10 is preferably scrambled using at least one scrambling key that is held by the content license 20. The scrambling key may be unique for each content item 10, but it may also be common to more than one content item 10, possibly all the content items 10 in the video database 150. In case the scrambling key is the same for all the content items 10, then a single, generic content license is sufficient. Each content license 20 is encrypted using a license key (that preferably is the same for all the content licenses, but that may also be different).

It is preferred to send the same content 10 and content license 20 to a player, regardless of whether the player is a fixed player 180 or a mobile player 170.

It is further preferred that each fixed player 180 executes the same player software with (generally) the same parameters. The skilled person will appreciate that it is also possible for e.g. different groups of fixed players to execute different player software; an example is that players having different screen sizes or capabilities (such as 3D capability) execute different player software or at least use different parameters.

However, each mobile player 170 receives a specific personalised secure player 30 that has been generated by the application server 110. This secure player 30 preferably comprises:
A dedicated secret used to receive user licenses 40.
A unique payload to be used for insertion of forensics watermarks.
A secret unique to the proximity server 160. During execution, the personalised secure player regularly checks the presence of this proximity server 160. If the proximity server 160 is not in the presence of the mobile player 170 (which may be checked using any suitable prior art protocols—there are many), the personalised secure player stops working.

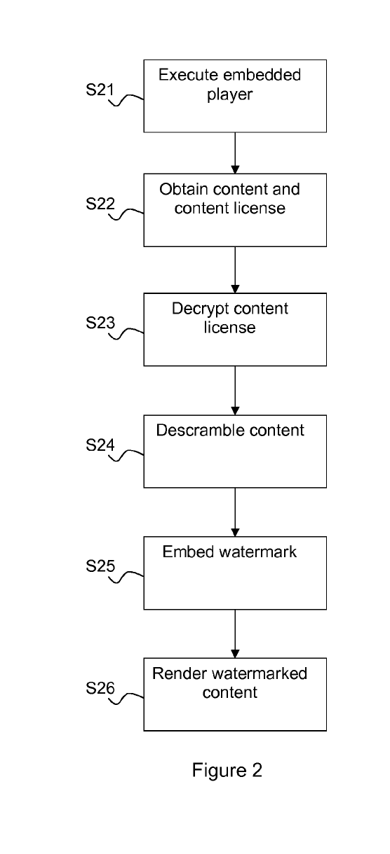

FIG. 2 illustrates a method for accessing content by a fixed player according to a preferred embodiment of the present invention.

First the fixed player 180 executes S21 an embedded software player that holds the license key common to all fixed players of the airplane (or at least to a group of fixed players). The fixed player 180 obtains S22 content 10 and a content license 20 from the video server 140. The fixed player 180 then attempts to decrypt S23 the content license 20 using the license key to obtain the scrambling key. It will be appreciated that the operation normally is successful. The fixed player 180 then uses the scrambling key to descramble S24 the scrambled content 10. Then an invisible (and possibly a visible watermark) is embedded S25 in the content 10. The skilled person will appreciate that the watermark can allow tracing of leaked content. The payload of the watermark may comprise features from the following non-exhaustive list: an identifier of the airline company, an identifier of the plane, an identifier of the flight, an identifier of the screen (i.e. the seat) and the current time. The watermarked content is then rendered S26.

It will be appreciated that in a variant embodiment, the content 10 in the video database 150 is watermarked with for example the identity of the plane.

In this case, there may be no need for the fixed player 180 to watermark the content.

The skilled person will note that this is a rather conventional method. The security assumption is that the “screen” (or “seat”) is rather secure.

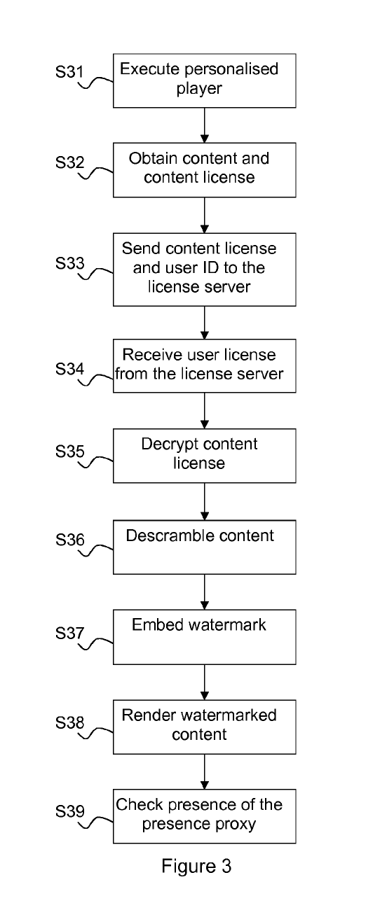

FIG. 3 illustrates a method for accessing content by a mobile player according to a preferred embodiment of the present invention.

For a mobile player 170 to access content, it has first to obtain a personalised secure player 30 from the application server 110. For that purpose:
The mobile player 170 executes a web browser and relays information 50 between a user and the registration server 120. The information 50 comprises credentials that will identify the user.
The registration server 120 analyses the credentials and then decides whether the user is granted access to at least one of the services of the IFE head-end, notably access to the content 10 in the video database 150. It will be appreciated that how the decision is made is beyond the scope of the present invention. In case of a positive decision, i.e. if access is granted, then the registration server 120 registers the user.
The registration server 120 preferably defines three parameters for the user:
   a unique user identity,
   a unique user license key, and
   a unique user watermark identity.
The registration server 120 forwards the parameters to the application server 110 that builds the personalised secure player 30 for the mobile player 170. The personalised secure player 30 is preferably obfuscated and securely embeds the user license key, the user watermark identity, and an address of the presence proxy 160.
The mobile player 170 is then notified, preferably by the registration server 120 or the application server 110, that the personalised secure player 30 may be downloaded, but the personalised secure player 30 may also be pushed to the mobile player 170.
The mobile player 170 then executes S31 the personalised secure player 30.

Once the mobile player 170 executes the personalised secure player 30, it may access content 10 by:
Obtaining S32 content 10 and the content license 20 from the video server 140.
Sending S33 the content license 20 and its own user identity to the license server 130.
At this point, the license server 130 checks with the registration server 120 that a mobile device 170 associated with the user identity is granted access to content. If so, the license server 130 builds a user license 40 that comprises the scrambling key and that is encrypted so that only the personalised secure player corresponding to the user identity can decrypt it using the user license key. The user license 40 is then returned to and received S34 by the personalised secure player 30.
Decrypting S35 the user license 40 using the user license key and retrieving the scrambling key.
Descrambling S36 the content 10 using the retrieved scrambling key.
Embedding S37 an invisible watermark (and possibly also a visible watermark) that can allow tracing of leakage of the content 10. The payload of the watermark is preferably at least the user watermark identity, but other data such as a combination of one or more of the features used for the ‘fixed player’ watermark described hereinbefore may be used in addition.
Rendering S38 the watermarked content 10.
During the rendering of the content 10, the mobile player 170 regularly (or at irregular intervals) at least once verifies S39 the presence of the proximity server 160. In case the mobile player 170 does not obtain an accepted response (i.e. if the proximity server 160 is not ‘present’), the mobile player stops rendering the content 10. The response may be unacceptable on account of it being wrong or because the distance to the proximity server 160 is too great. It will be appreciated that this verification may also be made at a point before the rendering begins.

Typically, the mobile player 170 and the proximity server 160 perform a challenge-response protocol—many such suitable protocols are well known in the art, such as for example limiting the number of ‘hops’ (see e.g. EP 1926250) or by limiting the round-trip time. It is also possible to require the two to be connected by one, non-relayed, radio (e.g. WiFi) connection. It can thus be ensured that the proximity server 160 is ‘local’ to the mobile player 170, i.e. that they are located on the same plane or in the same building. The proximity server 160 can also be configured to not respond during e.g. take-off and landing so as to help inhibit the use of electronic devices then.

In a preferred embodiment:
Content 10 is scrambled using AES-128. Thus, the scrambling key is a (random) 128-bit number.
The content license 20 and the user license 40 are protected by RSA-1024. To that end, each fixed player 180 has a common RSA-1024 public key K_{pub}_{_{—}}ₚₗₐₙₑ. The content license 20 is encrypted using the corresponding common private key Kₚᵣᵢ_{_{—}}ₚₗₐₙₑ. In addition, the license server 130 also possesses the common RSA-1024 public key K_{pub-plane}.
When registering a user, the registration server 120 creates a 128-bit random number as the user identity and a unique RSA-1024 key pair {K_{pub}_{_{—}}_{tablet}_{_{—}}ᵢ, Kₚᵣᵢ_{_{—}}_{tablet}_{_{—}}ᵢ}.
The registration server 120 logs the transaction with the provided credentials, the user identity, the flight number, and the date. The log is kept by the airline company and used in case of litigation.
The proximity server 160 has a unique AES 128 bit key K_{proxy}.
The personalization of the personalised secure player 30 is made by:
   Embedding an obfuscated AES using a key K_{tablet}. The player 30 expects to find at specific locations the four parameters (user identity, user license key (i.e. K_{pub}_{_{—}}_{tablet}_{_{—}}ᵢ), user watermark identity (preferably the user identity), and K_{proxy}) encrypted using K_{tablet}.
   Encrypting the four parameters with K_{tablet} and storing them in the proper memory locations. Then it packages the final personalised secure player 30.
When the license server 130 receives the content license 20 and the user identity, it forwards the user identity to the registration server 120. If the corresponding user is already registered, the registration server 120 returns the corresponding Kₚᵣᵢ_{_{—}}_{tablet}_{_{—}}ᵢ. The license server 130 decrypts the content license 20 using K_{pub}_{_{—}}ₚₗₐₙₑ and generates the user license 40 by encrypting the decrypted content license 20 with Kₚᵣᵢ_{_{—}}_{tablet}_{_{—}}ᵢ. The user license 40 is then sent to the mobile player 170.
The mobile player 170 decrypts the user license 40 with Kₚᵣᵢ_{_{—}}_{tablet}_{_{—}}ᵢ and descrambles the content 10 using the scrambling key.
Every minute, the personalised secure player generates a random number R, encrypts R using K_{proxy} and sends it to the proximity server 160. The proximity server 160 returns R+1 encrypted with K_{proxy}. The personalised secure player checks whether the returned value was incremented. After two successive failures, the personalised secure player stops the play back of the content 10.

The skilled person will appreciate that the system of the invention can offer the following advantages:
end-to-end security for highly valuable content,
high traceability of content in case of leakage, and
use of a user's personal device as rendering unit.

It will thus be appreciated that the present invention provides an improved IFE system. It will be understood that the present invention is not limited to IFE, but that it may also be used e.g. in a museum where the solution may be modified so that the ‘fixed players’ are the museum's owned mobile players.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1-11. (canceled)

12. A method of rendering a content item, the method comprising the steps, in a device having a processor executing a player, of:
rendering the content item;
and wherein, at at least one point of time during execution of the method, it comprises:
verifying a presence of a proximity server; and
stopping the rendering of the content item in case the proximity server is not present.

13. The method of claim 12, wherein the device has a user identity and the player has been personalised to comprise the user identity and a user license key for the device, the method further comprising the steps of:
sending a content license for the content item and the user identity to a license server;
obtaining a user license for the content item from the license server;
decrypting the user license using the user license key to obtain a scrambling key; and
descrambling the content item using the scrambling key.

14. The method of claim 13, further comprising the step, between the descrambling step and the rendering step, of watermarking the content.

15. The method of claim 14, wherein the player has further been personalised to comprise a user watermark identity and the content is watermarked with the user watermark identity.

16. The method of claim 13, further comprising the prior steps of sending user credentials to a registration server and of receiving the player.

17. The method of claim 13, further comprising the step of obtaining the content item and the content license.

18. The method of claim 13, wherein user license has been generated from the content license.

19. The method of claim 12, wherein the presence of a proximity server is defined in function of a distance between the proximity server and said device.

20. A content delivery system wherein it comprises
a player device being able to receive and render at least one content item;
a proximity server;
means for verifying a presence of the proximity server at at least one point of time during reception of the at least one content item by the player device; and
means for stopping the player device in case the proximity server is not present.

21. The content delivery system of claim 20, further comprising:
a content database configured to store at least one content item and a corresponding content license;
a video server configured to retrieve a content item and a corresponding content license from the content database and to send the retrieved content item and corresponding content license to the player device;
an application server configured to receive user information from the registration server, to generate a personalised player application for the user player device and to deliver the personalised player application to the user player device;
a license server configured to receive a content license and a user identity from the user player device, to check with the registration server that a user corresponding to the user identity is authorized to access the content item, to decrypt the content license using a system license key and re-encrypt the decrypted content license using a user license key to obtain a user license, and to send the user license to the user player device; and
a the proximity server configured to participate in a challenge-response protocol with the user player device.

22. The content delivery system of claim 21, further comprising a registration server configured to receive credentials from a user player device, to generate the user information from the credentials, to forward the user information to an application server.

23. The content delivery system of claim 21, further comprising a system player device comprising the system license key, the system player device being configured to receive the content item and the corresponding content license, to decrypt the content license using the system license key to obtain a scrambling key, to descramble the content item using the scrambling key, and to render the descrambled content item.

24. The content delivery system of claim 23, wherein the system player device is further configured to embed a watermark in the descrambled content item before rendering.
